(19) United States
(12) Patent Application Publication
(10) Pub. No.: US 2024/0086246 A1
(43) Pub. Date: Mar. 14, 2024

(54) Allocating Computational Tasks to Computer Hardware

(71) Applicant: Xonai Ltd., London (GB)

(72) Inventor: Brock Gilles Doiron, Ingatestone Essex (GB)

(21) Appl. No.: 18/264,049

(22) PCT Filed: Feb. 3, 2022
(86) PCT No.: PCT/GB2022/050294

§ 371 Date: Aug. 2, 2023

(30) Foreign Application Priority Data
Feb. 3, 2021 (GB) 2101506.0

(51) Int. Cl. G06F 9/50

(52) U.S. Cl. CPC G06F 9/5038; G06F 9/5044; G06F 9/5072

(57) ABSTRACT

A computer-implemented method of allocating computational tasks to computer hardware, the method comprising: constructing a graph comprising a plurality of nodes and edges, each node representing a respective computational task and each edge representing a data flow between computational tasks; determining one or more instances of available computer hardware capable of performing each computational task; and allocating each computational task to one or more of the one or more instances of computer hardware determined for that computational task such that a data bandwidth between the one or more instances of computer hardware to which each computational task is allocated satisfies a data flow requirement between each computational task.

### BACKGROUND

### Field of the Disclosure

The present disclosure relates to allocating computational tasks to computer hardware.

### Description of the Related Art

The “background” description provided is for the purpose of generally presenting the context of the disclosure. Work of the presently named inventors, to the extent it is described in the background section, as well as aspects of the description which may not otherwise qualify as prior art at the time of filing, are neither expressly or impliedly admitted as prior art against the present disclosure.

It is sometimes desirable to distribute computational tasks amongst different instances of hardware (that is, different hardware components). For example, a set of computational tasks for training a machine learning algorithm may include some tasks for which a central processing unit (CPU) is most appropriate (e.g. a task requiring a small number of concurrent processes and computational flexibility in how it is carried out) and some tasks for which a graphics processing unit (GPU) is most appropriate (e.g. a task requiring less computational flexibility but having a large number of concurrent processes which must be performed).

The optimal way to allocate different tasks to different instances of hardware is highly dependent on the tasks and how they relate to each other (e.g. the data flow between different tasks). Different users may also have different optimisation requirements. For example, one user might have a preference for the tasks to be completed as quickly as possible (no matter what the cost) whereas another user may accept the tasks being completed more slowly if e.g. cost or power consumption is reduced. This applies to both local instances of hardware (in which the user must purchase the hardware they wish to use) and cloud-based instances of hardware (in which the user rents the hardware capacity of a third party).

Optimal task allocation is currently done manually. That is, for a particular set of computational tasks, the user will determine which tasks will be completed by which instance of hardware and will individually code each task so it can be performed by that hardware. This is time consuming. It is also very inflexible if the user's optimisation requirements are changed. For example, if a user initially allocates each task in a way which maximises processing speed but then realises the cost of doing this is unacceptably high, reallocation of the tasks to reduce the cost requires the user to manually redesign the allocation and recode tasks which are now to be performed by different (e.g. cheaper) hardware. With tens of thousands of lines of code being common, it is often difficult to even find which code is driving up the costs. The manual effort to find the problems, decide on hardware and then modify the code to suit the hardware is therefore significant. This results in computational task allocation being a slow, inefficient and inflexible process.

### SUMMARY

The present disclosure is defined by the claims.

### BRIEF DESCRIPTION OF THE DRAWINGS

Non-limiting embodiments and advantages of the present disclosure are explained with reference to the following detailed description taken in conjunction with the accompanying drawings, wherein:

FIG. 1 illustrates an example problem of computational task allocation.

FIG. 2 shows an information processing apparatus/device according to an embodiment.

FIG. 3 shows automatic task determination according to an example.

FIG. 4 shows an example hardware allocation based on first parameter optimisation requirements of a user.

FIG. 5 shows an example hardware allocation based on second parameter optimisation requirements of a user.

FIG. 6 shows a specific implementation example of allocating computational tasks to computer hardware.

FIG. 7 shows a method according to an embodiment.

Like reference numerals designate identical or corresponding parts throughout the drawings.

### DETAILED DESCRIPTION OF THE EMBODIMENTS

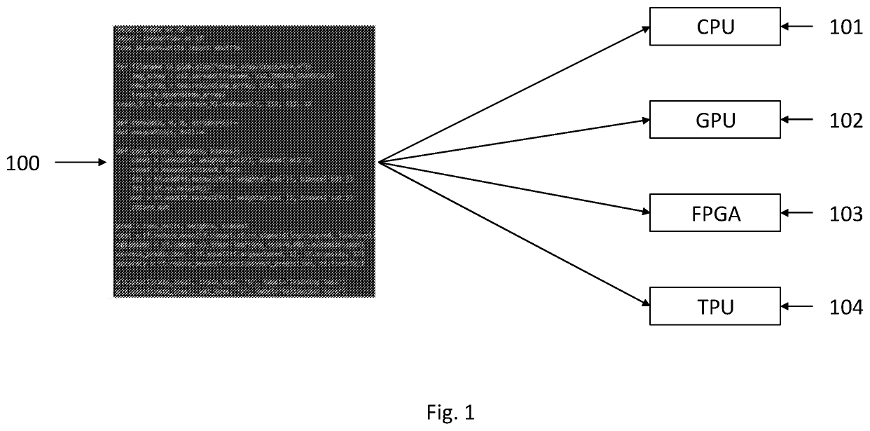

FIG. 1 illustrates a problem of computational task allocation. A piece of source code (e.g. for implementing a machine learning training algorithm) contains a plurality of computational tasks. Each task will be most suited to a different type of computer hardware for performing that task. This also depends on what the user wishes to optimise. In this example, available hardware for performing each task includes one or more CPUs 101, one or more GPUs 102, one or more field-programmable gate arrays (FPGAs) 103 and one or more tensor processing units (TPUs) 104. The user must therefore first decide which task to allocate to which instance of hardware. If necessary, they must then recode that task so it can be performed on that hardware. This is particularly the case for specialised components such as GPUs, FPGAs and TPUs. This is a slow, inefficient and inflexible process.

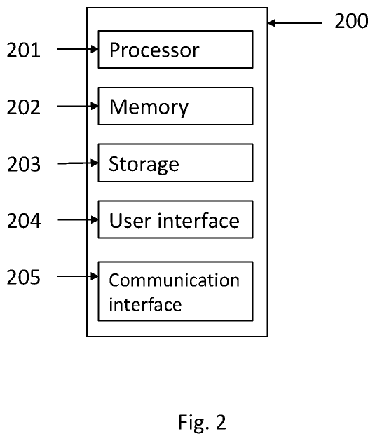

FIG. 2 shows an information processing apparatus/device according to an embodiment. It comprises a processor 201 for executing electronic instructions, a memory 202 for storing the electronic instructions to be executed and electronic input and output information associated with the electronic instructions, a storage medium 203 (e.g. a hard disk drive or solid state drive) for long term storage of information, a user interface 204 (e.g. a touch screen, a non-touch screen, buttons, a keyboard and/or a mouse) for receiving commands from and/or outputting information to a user and communication interface 205 for sending electronic information to and/or receiving electronic information from one or more other apparatuses (e.g. over a communications network such as the internet). Each of the processor 201, memory 202, storage medium 203, user interface 204 and communication interface 205 are implemented using appropriate circuitry, for example. The processor 201 controls the operation of each of the memory 202, storage medium 203, user interface 204 and communication interface 201.

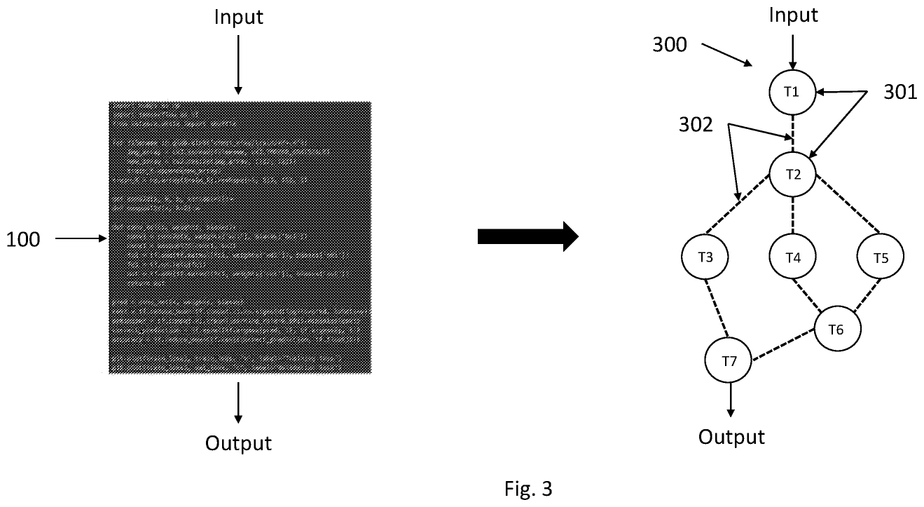

FIG. 3 shows automatic task determination according to an example. Source code 100 represents a plurality of computational tasks which, when performed together, allows input data to be converted to output data. The input data is, for example, a set of training data for training an artificial neural network. The output data is, for example, parameters of the artificial neural network (e.g. node weights) determined based on the training data.

The processor 201 parses the source code 100 to determine a plurality of computational tasks T1-T7 each to be performed by a respective instance of hardware. Each computational task comprises one or more processes (e.g. an individual operation or a collection of operations to form function(s), algorithm(s) and/or service(s)) which must be performed by the same instance of hardware (e.g. due to data dependencies between the processes and/or latency requirements). The processor 201 also determines the data flow between the computational tasks (that is, the other computational task(s) each computational task provides input data to and/or receives output data from). The processor then constructs a graph 300 representing this information. Each node 301 of the graph represents a task. Each edge 302 of the graph represents a data flow between tasks.

In the example of FIG. 3, input data of the source code 100 (e.g. training data) is received by T1. T1 is performed on the input data and the output of T1 is provided to T2. T2 is performed on the output of T1 and the output of T2 is provided to T3, T4 and T5. T3 is performed on the output of T2 and the output of T3 is provided to T7. T4 is also performed on the output of T2 and the output of T4 is provided to T6. T5 is also performed on the output of T2 and the output of T5 is also provided to T6. T6 is performed on the output of T4 and T5 and the output of T6 is provided to T7. T7 is performed on the output of T3 and T6 to generate the output data of the source code 100 (e.g. artificial neural network parameters).

In reality, the source code may be complex and be broken down into a much larger number of tasks than the seven given in this example (thereby resulting in a much larger and more complex graph). However, for simplicity, we stick to a small number of tasks here to illustrate the principle (which is the same regardless of the number of tasks).

Once the graph is generated, the processor 201 determines, from a set of available hardware components (including local and/or cloud-based hardware components), which hardware component(s) are most appropriate for performing each task. This is based on the nature of each task and one or more parameters the user wishes to optimise.

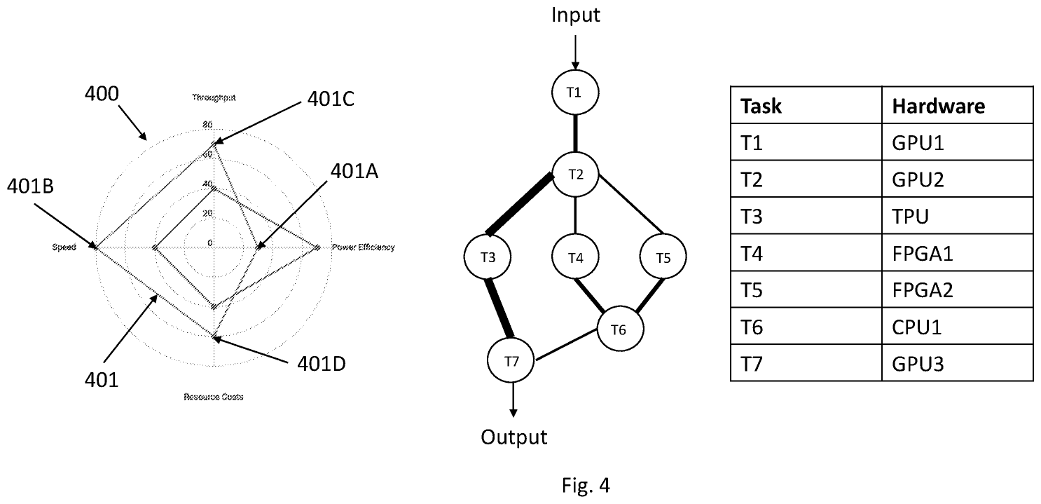

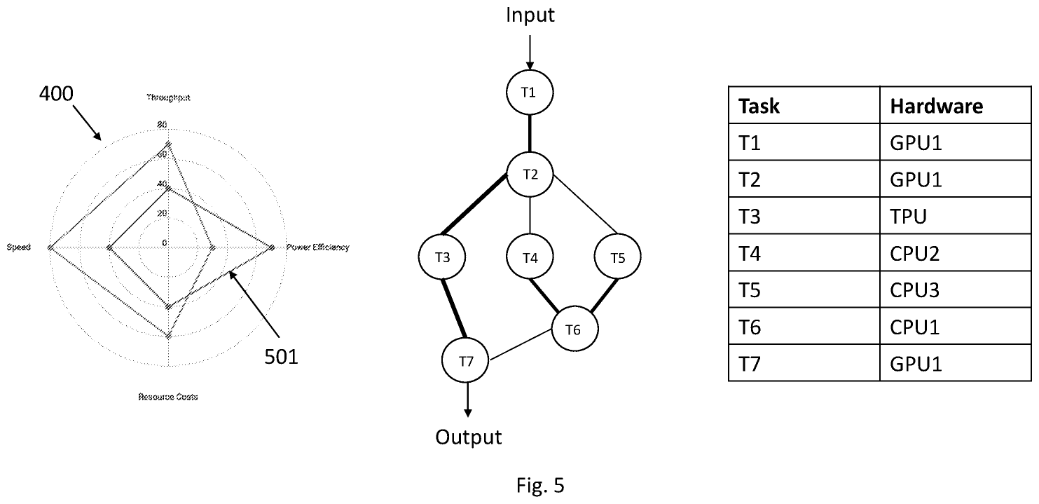

FIGS. 4 and 5 show different example hardware allocation based on different parameter optimisation requirements of the user. FIG. 4 shows a hardware allocation provides higher speed and throughput (at the expense of higher resource cost and lower power efficiency). This is illustrated by the parameter optimisation selection 401 on parameter optimisation graph 400. FIG. 5 shows a hardware allocation which provides lower resource cost and higher power efficiency (at the expense of lower throughput and speed). This is illustrated by the parameter optimisation selection 501 on parameter optimisation graph 400.

“Speed” represents the time taken for a single instance of input data (e.g. a single instance of training data from a training data set, such as a single training image from a set of training images) to be converted to output data via the computational tasks T1-T7. A higher speed is associated with the single instance of input data being converted to output data more quickly whereas a lower speed is associated with the single instance of input data being converted to output data more slowly.

“Throughput” represents the rate at which input data is converted to output data. It is related to speed (because, everything else being equal, a higher speed will result in a higher throughput) but can be achieved without an increase in speed. For example, if multiple instances of input data (e.g. multiple training images from a set of training images) can be converted to output data in parallel (even if the speed at which each conversion takes place is unchanged), the throughput will be increased.

“Resource costs” represents the financial cost of buying or renting the hardware. Usually, more advanced hardware (e.g. with higher speed and/or throughput) is more costly than less advanced hardware (e.g. with lower speed and/or lower throughput).

“Power efficiency” represents the power consumption of the hardware components used to perform the tasks T1-T7. It may take the form of the scientific conversion efficiency (i.e. the proportion of input energy converted to useful energy) or may be based on an absolute value of energy consumption, for example.

A higher speed and/or throughput of input data to output data generally requires a greater data flow rate (e.g. bits per second) between tasks than a lower speed and/or throughput of input data to output data. Some tasks (e.g. those involving multiple input and/or output variables) will generally input and/or output more data in a given time than other tasks (e.g. those involving single input and/or output variables). This will be reflected in the required data flow rates between tasks (i.e. the inter-task data flow rate) as the overall speed and/or throughput of input data to output data changes. For example, tasks involving multiple input and/or output variables will have a data flow rate which increases faster (in terms of absolute data flow) than tasks involving only a single input and/or output variable. For example, if the desired throughput is doubled, a task which initially inputs and outputs 8 bits of data per second will need to now input and output 16 bits of data per second (an increase of 8 bits per second) whereas a task which initially inputs and outputs 64 bits of data per second will now need to input and output 128 bits of data per second (an increase of 64 bits of data per second). A change in the overall input and output data throughput for a given set of tasks may therefore result in different data flow rate requirements between different tasks in the set.

This is exemplified in FIGS. 4 and 5, in which the required data flow rate between tasks is illustrated by the thickness of the edges between the nodes representing those tasks. In FIG. 4, the higher overall speed and throughput of input data to output data results in the highest data flow rate requirements (indicated by the thickest lines) between tasks T2 and T3 and tasks T3 and T7. The second highest data flow rate requirements (indicated by lines of medium thickness) are between tasks T1 and T2, tasks T4 and T6 and tasks T5 and T6. The lowest data flow rate requirements (indicated by the thinnest lines) are between tasks T2 and T4, tasks T2 and T5 and tasks T6 and T7. In FIG. 5, the lower overall speed and throughput of input data to output data results in corresponding lower data flow requirements between tasks. This is reflected in the reduction in line thicknesses.

The ratio between line thicknesses remains the same for a given set of tasks. For the sake of example, let's assume the overall speed of data input to data output in FIG. 4 is double that of FIG. 5. If the thickest lines in FIG. 4 (between tasks T2 and T3, T3 and T7) represent a data flow rate of 5 Gbps, then the corresponding lines in FIG. 5 represent a data flow rate of 2.5 Gbps. If the lines of medium thickness in FIG. 4 (between tasks T1 and T2, T4 and T6, T5 and T6) represent a data flow rate of 3 Gbps, then the corresponding lines of FIG. 5 represent a data flow rate of 1.5 Gbps. If the thinnest lines in FIG. 4 (between tasks T2 and T4, T2 and T5, T6 and T7) represent a data flow rate of 1 Gbps, then the corresponding lines of FIG. 5 represent a data flow rate of 0.5 Gbps. These data flow rates are examples for demonstration and, in reality, the data flow rates may be significantly different depending on the nature of the tasks performed. The principle, however, remains the same.

When the necessary data flow rates between tasks have been determined, the processor 201 selects a hardware component for each task which is able to deliver the input and output data flow rate required for that task. The processor 201 has access to information associated with each available hardware component. In an example, this information is representative of a software simulation of each hardware component. This information is stored in the storage medium 203 or an external storage medium (not shown) accessible via communication interface 205, for example. The processor 201 causes each task to be run on the software simulation of one or more of the available hardware components to determine whether or not the required input and output data flow rates are met. If the requirement input and output data flow rates are met, then this hardware component is shortlisted as being a suitable component for carrying out the task in real life. A component is then chosen from the shortlisted components based on, for example, which component has the lowest cost and/or best power efficiency (e.g. based on predetermined preferences of the user). If the requirement input and output data flow rates are not met for a particular hardware component, the hardware component is determined not to be suitable for this particular task. This allows the set of hardware components with which the set of tasks is to be performed to be determined in advance based on which parameter(s) are most important to the user. A suitable set of executable files can then be generated for execution by the hardware components which are to perform the set of tasks.

In an example, the information representative of the software simulation of the available hardware components comprises a graph representing the available hardware components (represented by nodes) and the interconnects between the available hardware components (represented by edges, with the interconnect bandwidth represented by the edge thickness). The graph also includes metadata for each hardware component. The metadata includes information necessary for making a suitable hardware allocation of the tasks depending on the user's requirements. For example, the metadata may include the cost and clock speed of each component (in addition to the interconnect bandwidth represented by the edge thickness linking different components). The metadata is generated in advance by benchmarking experiments, for example. The use of a graph in this way provides a standard (and extensible) data structure to represent dissimilar hardware with different architectures. The hardware components allocated to nodes can be at the level of processing units and/or processing cores and the interconnects can be at the level of on-chip and/or between-chip. This allows easier hardware allocation for a given set of tasks (also represented by a graph) according to the present technique.

Looking at the example of FIG. 4 and using the mentioned example data flow rates, the processor 201 needs to find a first hardware component which performs T1 with an output data flow rate of 3 Gbps, a second hardware component which performs T2 with an input data flow rate of 3 Gbps and an output data flow rate of 5+1+1=7 Gbps (reflecting the required input data flow rates of T3, T4 and T5, respectively), a third hardware component which performs T3 with an input and output data flow rate of 5 Gbps, a fourth hardware component which performs T4 with an input data flow rate of 1 Gbps and an output data flow rate of 3 Gbps, a fifth hardware component which performs T5 with an input data flow rate of 1 Gbps and an output data flow rate of 3 Gbps, a sixth hardware component which performs T6 with an input data flow rate of 3+3=6 Gbps (reflecting required output flow rates of T4 and T5, respectively) and an output data flow rate of 1 Gbps and a seventh hardware component which performs T7 with an input data flow rate of 5+1=6 Gbps (reflecting required output flow rates of T3 and T6, respectively). In this case, from the available hardware, the processor 201 determines a first GPU (GPU1) to perform T1, a second GPU (GPU2) to perform T2, a TPU to perform T3, a first FPGA (FPGA1) to perform T4, a second FPGA (FPGA2) to perform T5, a first CPU (CPU1) to perform T6 and a third GPU (GPU3) to perform T7. This allows higher overall speed and/or throughput of input data to output data at the expense of lower power efficiency and higher resource costs.

Looking at the example of FIG. 5 and using the mentioned example data flow rates, the processor 201 needs to find a first hardware component which performs T1 with an output data flow rate of 1.5 Gbps, a second hardware component which performs T2 with an input data flow rate of 1.5 Gbps and an output data flow rate of 2.5+0.5+0.5=3.5 Gbps (reflecting the required input data flow rates of T3, T4 and T5, respectively), a third hardware component which performs T3 with an input and output data flow rate of 2.5 Gbps, a fourth hardware component which performs T4 with an input data flow rate of 0.5 Gbps and an output data flow rate of 1.5 Gbps, a fifth hardware component which performs T5 with an input data flow rate of 0.5 Gbps and an output data flow rate of 1.5 Gbps, a sixth hardware component which performs T6 with an input data flow rate of 1.5+1.5=3 Gbps (reflecting required output flow rates of T4 and T5, respectively) and an output data flow rate of 0.5 Gbps and a seventh hardware component which performs T7 with an input data flow rate of 2.5+0.5=3 Gbps (reflecting required output flow rates of T3 and T6, respectively). In this case, from the available hardware, the processor 201 determines the first GPU (GPU1) to perform T1, T2 and T7, the TPU to perform T3, a second CPU (CPU2) to perform T4, a third CPU (CPU3) to perform T5 and the first CPU (CPU1) to perform T6. In other words, GPU2, GPU3, FGPA1 and FGPA2 in FIG. 4 have been replaced with GPU1, GPU1, CPU2 and CPU3, respectively. This allows improved power efficiency and reduced resource costs at the expense of lower speed and/or throughput of input data to output data.

In each of FIG. 4 and FIG. 5, the chosen components represent a subset of components identified by information stored in the storage medium 203 (or an external storage medium (not shown) accessible via communication interface 205) which meet the data flow rate requirements of each task and the constraints of power efficiency and resource costs chosen by the user. The set of selected components may be chosen by the processor using any suitable method. For example, every possible combination of hardware components could be simulated for the given set of tasks and the combination which, based on the simulation, best optimises the desired parameters is selected. In another example, one or more characteristics of each task are used to narrow down the type(s) of hardware component best suited for performing that task. Only hardware components of those type(s) are then simulated for that particular task. For example, a task involving only a small number (e.g. 4 or 8) of parallel processes is likely to be best performed by a CPU (e.g. with 4 or 8 cores), and therefore only available CPUs would be simulated for performing this task. On the other hand, a task involving a large number (e.g. 100s) of parallel processes is likely to be best performed by a GPU (e.g. with 100s of cores), and therefore only GPUs would be simulated for performing this task. In another example, it is envisaged a suitable machine learning algorithm could be used to associate certain tasks with particular type(s) of hardware components likely to be most suitable for performing that task. In another example, a suitable graph matching or inexact graph matching technique may be used to try to find the best match between the task graph (e.g. of FIG. 4 or 5) and another graph representing the available hardware components (represented by nodes) and the interconnects between the available hardware components (represented by edges, with the interconnect bandwidth represented by the edge thickness). In this case, a suitable machine learning model trained using past performance data of interconnected hardware component combinations in implementing particular task graphs (or portions of task graphs) may be used to determine a suitable graph match, The graph match provides a correspondence between nodes of the task graph and available hardware component graph, thereby indicating which available hardware component is to perform which task These are only examples and any suitable way of determining which of a set of available hardware components should perform which task to meet a given set of constraints may be used.

The data flow rate between tasks may be determined in any suitable way.

In one example, for one instance of input data (e.g. an image of the data size of images to be used for training a machine learning algorithm), the amount of data which flows between each task to fully complete the processing of input data to output data for that image may be calculated. The required throughput is then determined (e.g. 100 images per second) and this is then used to determine the data flow rate. For example, if the processing of the single image requires 1 MB of data to be transferred between tasks T1 and T2, then, at the required throughput of 100 images per second, a data flow rate of 100 MB/s is required between tasks T1 and T2.

In another example, the data flow rate may be determined by, for example, considering the number of function calls and/or loops implemented by each task. Typically, a function call or loop will call data from other tasks. Given an estimated required data flow rate for a single call (e.g. 1 MB/s), the data flow rate between pairs of tasks can be determined. For example, a first task with 10 function calls to a second task will be estimated as having a required data flow rate with respect to the second task of 10 MB/s. On the other hand, a third task with 100 function calls to the second task will be estimated as having a required data flow rate with respect to the second task of 100 MB/s.

These are only examples and other suitable methods of calculating the data flow rate between tasks may be used with the present technique.

In an example, an interactive version of the parameter optimisation graph 400 is provided via the user interface 204 to allow the user to easily select which parameter(s) they wish to optimise. For example, if user interface 204 is a touch screen, the user may adjust the parameter(s) they wish to optimise using a suitable select and drag operation. For example, if the user, starting from the parameter selection in FIG. 4, wishes to increase the power efficiency, they will select and drag the relevant part 401A of the parameter optimisation graph 401 to the right. This will increase the power efficiency constraint on the selected hardware components. In this case, it is not possible to achieve the desired power efficiency whilst maintaining the task data flow rates of FIG. 4. In an example, the user is therefore presented with a message (not shown) asking them to reduce the speed and/or throughput. The user does this by dragging part 401B of the graph 401 to the right (thereby reducing the speed constraint) and/or dragging part 401C of the graph downwards (thereby reducing the throughput constraint). This reduces the data flow requirements of the selected hardware components (e.g. to those of FIG. 5), thereby increasing the choice of selectable hardware components and allowing more power efficient hardware components to be selected. The user may also be required to adjust the resource cost constraint (e.g. increasing it to allow more costly but more energy efficient hardware to be selected). They do this by dragging part 401D of the graph 401 up (to reduce the allowable resource cost) or down (to increase the allowable resource cost). The user is thus able to easily adjust each parameter (throughput, speed, resource costs and power efficiency) to enable a suitable set of hardware components to be selected which meet the constraints imposed by those parameters. In particular, for a given set of inter-task data flow rates (determined by the speed and throughput constraints), the processor 201 is able to select, based on simulating each available hardware component, a hardware component for performing each task which satisfies the data flow rates for that task and meets power efficiency and/or resource cost requirements.

In an example, adjusting one parameter of the graph may result in automatic adjustment of one or more of the other parameters. For example, if the throughput and/or speed parameters are adjusted (leading to a corresponding adjustment of the inter-task data flow rates), the processor 201 may automatically adjust the power efficiency and/or resource costs accordingly. For instance, for a given set of inter-task data flow rates, the processor 201 may be configured to select hardware which (i) maximises the power efficiency, (ii) minimises the resource costs or (iii) finds an optimal balance between the two (e.g. by assigning each of power efficiency and resource costs a predetermined rating and optimising an average of the two ratings). The user may select which of (i), (ii) or (iii) the processor 201 does in advance (e.g. via an interactive menu provided by user interface 204) or may manually adjust the power efficiency and/or resource cost constraints on the graph 400 once they have selected an appropriate speed and/or throughput.

In another example, the user may select a set of parameter constraints for a predetermined time period (e.g. a daily cost budget and speed/throughput requirement) and, as network traffic changes over the predetermined time period (affecting the supply and demand and therefore the cost of available hardware), tasks are reallocated between the available hardware to try to meet the parameter constraints. For example, over the course of a day, tasks may be allocated to cheaper, slower hardware when network traffic is high (and thus available hardware is more expensive) and reallocated to more expensive, faster hardware when network traffic is low (and thus available hardware is less expensive) so that, overall, the day's speed/throughput requirement is met within the set budget. In this case, the processor 201 may, for example, receive periodic and/or requested updates (via the communication interface 205) from a cloud computing network regarding the current network traffic associated with and/or cost of available hardware components of the cloud computing network. This allows the processor 201 to make real time decisions about task hardware allocation to try to meet the parameter constraints for the day.

The user may prioritise one or more specific parameter constraints in case it is not possible for all parameter constraints to be satisfied. For example, if the user's overriding concern is cost, the daily budget may be set as the parameter constraint with the highest priority. In this case, the processor 201 allows the speed/throughput requirement not to be met if it cannot be met within the daily budget (e.g. due to higher than expected network traffic making the available hardware more expensive than expected). In another example, if the user's overriding concern is that the speed/throughput requirement is met, the speed/throughput requirement is set as the highest priority parameter constraint and the processor 201 allows the daily budget to be exceeded if necessary in order to meet the speed/throughput requirement.

Thus, with the present technique, it is easy for the user to cause the processor 201 to determine hardware components which meet their speed and/or throughput requirements whilst also effectively managing power efficiency and resource cost constraints.

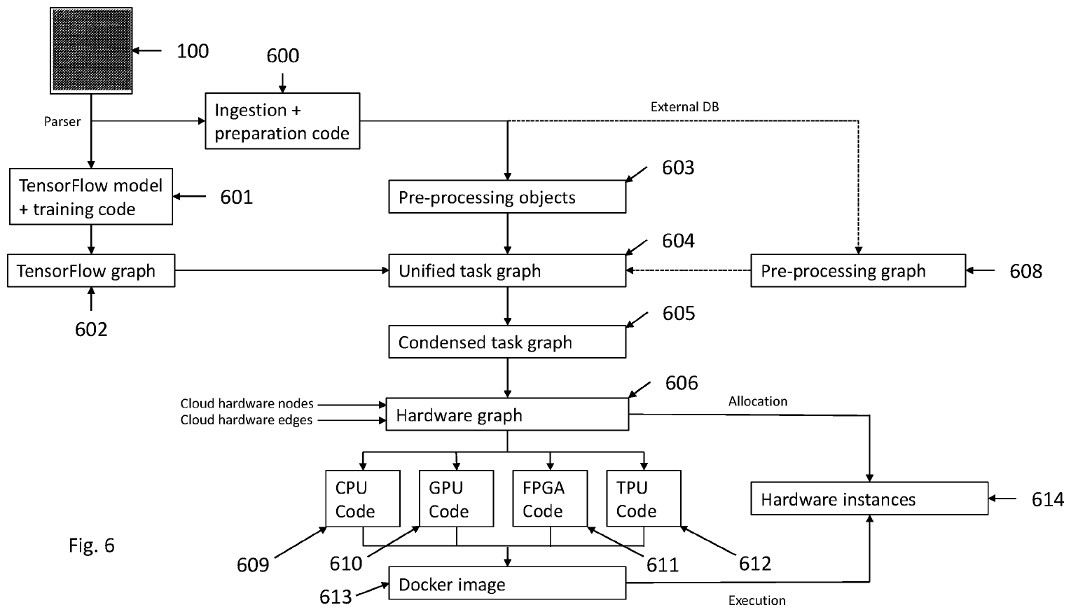

FIG. 6 shows an example of allocating computational tasks to computer hardware according to the present technique. This is only an example and different ways of implementing the present technique may be used.

The processor 201 parses computer code 100 to determine, from the code, an identified TensorFlow model and training code 601 and ingestion and preparation code 600. The TensorFlow model and training code 601 are distinguishable from the ingestion and preparation code 600 because the TensorFlow functions implementing the TensorFlow model and training code 601 have a predetermined, recognisable format. The processor 201 is therefore able to separate out lines of code containing such functions. In this example, the TensorFlow model is an example of a machine learning model and the training code represents an algorithm for training this machine learning model. The code 100 (including the ingestion and preparation code) is written in Python or Scala, for example.

The processor 201 generates a TensorFlow graph 602 represented by a TensorFlow machine learning intermediate representation (MLIR). The processor 201 pre-processes the ingestion and preparation code 600 to generate pre-processing objects 603. The pre-processing objects 603 are represented in an LLVM intermediate representation (LLVM IR) format, for example. In this case, an LLVM IR call graph is used which shows which functions depend on each other. The pre-processing objects 603 are groupings of the corresponding dependent code (variable declaration and ingestion). Optionally or in addition, the processor 201 may also look up the ingestion and preparation code in an external database (not shown). The identified ingestion and preparation code is then converted to a pre-processing graph 608 (e.g. in the LLVM IR format). The conversion is carried out using Spark DAG and a Java front-end, for example. The processor 201 uses the TensorFlow graph 602 and pre-processing objects 603 (and/or the pre-processing graph 608) to generate a unified task graph 604. In an example, the representation of the TensorFlow graph 602 is converted to an LLVM IR format for generation of the unified task graph 604. In an example, the processor 201 constructs the unified task graph 604 based on the data flow between libraries and pre-processing objects 603 (each pre-processing object 603 being represented by a corresponding node in the unified task graph 604). For example, if a user has images in a database for training a TensorFlow model, pre-processing objects 603 (resulting from custom pre-processing code) and the TensorFlow model, the unified task graph represents the entire flow from the database search (one node), pre-processing (the pre-processing object nodes) and input data tensor creation (one node).

The unified task graph 604 represents tasks as nodes and data flow between tasks as edges. In an example, the unified task graph 604 is represented in a suitable MLIR format (e.g. based on the Google® MLIR framework). In an example, an MLIR dialect (set of code optimisation functions) is chosen which optimises globally across the different libraries used (rather than optimising for any individual library) to help improve the performance of the set of tasks as a whole.

The unified task graph 604 represents all tasks as separate nodes even if, in reality, those tasks must be completed by the same instance of hardware. The processor 201 therefore converts the unified task graph 604 to a condensed task graph 605. The condensed task graph 605 (also represented using the MLIR dialect of the unified task graph 604, for example) groups tasks which must be completed by the same instance of hardware together so they are represented by the same node in the condensed task graph. In an example, a threshold data flow (e.g. in gigabits per instance of training data) is determined in advance. It is then determined that tasks with a data flow between them which exceeds this threshold data flow are to be performed by the same instance of hardware. This helps reduce latency by ensuring interdependent tasks with high data flow between them are carried out by the same instance of hardware (thus taking advantage of the high data flow rates enabled by the interconnects between components of the same instance of hardware, e.g. between CPU or GPU cores). The graphs of FIGS. 3-5 are examples of a condensed task graph 605.

The processor 201 uses the condensed task graph 605 to construct a hardware graph 606. The hardware graph 606 is the same as the condensed task graph 606 except it further specifies the instance of hardware associate with each node of the condensed task graph 605 determined in accordance with the user's optimisation requirements (as exemplified in FIGS. 4 and 5). That is, the hardware graph indicates which available hardware component performs each task of the condensed task graph 605. In constructing the hardware graph, the processor 201 looks up information associated with available hardware nodes (e.g. cloud and local clusters and cores) and available hardware edges (e.g. cloud and local memory bandwidth). This information is stored in the storage medium 203 or an external storage medium (not shown) accessible via communication interface 205, for example.

Once the hardware component to perform each task is determined, the processor 201 generates hardware-specific code for performing each task on its associate piece of hardware. In this example, the hardware chosen includes one or more CPUs, one or more GPUs, one or more FPGAs and one or more TPUs. The processor 201 therefore generates, as hardware-specific code, CPU code 609 (representing each task to be performed by a CPU), GPU code 610 (representing each task to be performed by a GPU), FPGA code 611 (representing each task to be performed by a FPGA) and TPU code 612 (representing each task to be performed by a TPU). In an example in which the tasks of the condensed task graph 605 are represented in an LLVM IR format, the processor 201 is provided with the necessary LLVM backend to enable the conversion of each task to the appropriate hardware-specific code. When one or more FPGAs are to be used, the processor 201 is also provided with the necessary FPGA bitstreams. Again, this information is stored in the storage medium 203 or an external storage medium (not shown) accessible via communication interface 205, for example. Each of the hardware-specific code takes the form of a suitable executable file to be executed by the appropriate hardware, for example.

The processor 201 generates a Docker image comprising the generated hardware-specific code and provides the Docker image (e.g. via communication interface 205) to the hardware instances 614 (e.g. the selected set of hardware components of FIG. 4 or FIG. 5) for execution. The processor 201 allocates each piece of generated hardware-specific code to its corresponding hardware component. This is carried out by, for example, assigning a unique identifier to each instance of hardware (e.g. so that GPU1 is distinguishable from GPU2 and GPU3, CPU1 is distinguishable from CPU2 and CPU3, etc.) and including this unique identifier in the hardware-specific code (e.g. in the code header) for that instance of hardware.

The present technique thus allows computer code (e.g. machine learning training code) to be quickly and easily distributed amongst multiple hardware components in different ways depending on a user's requirements. For example, a user is able to prioritise speed and throughput or to prioritise as resource cost and power efficiency. The user is able to do this without having to manually rewrite the code for different hardware components each time. The present technique thus allows faster, more efficiency and more flexible computational task allocation.

Although the example hardware components given are CPUs, GPUs, FPGAs and TPUs, any other suitable hardware component may also be allocated tasks according to the present technique. Other hardware components may include, for example, other types of artificial intelligence (AI) optimised processors (other than TPUs), neuromorphic processors or quantum computing processors.

Although in the given examples, each task of the condensed task graph 605 (e.g. T1-T7) is allocated to a single hardware component, in some instances, a task may be broken down into subtasks and those subtasks allocated to different respective hardware components. In this way, the task is carried out by a plurality of hardware components (which may be referred to as a hardware set). This is suitable for certain tasks with a required data flow rate between subtasks which can be satisfied by the interconnects between the hardware components in the hardware set. This is not necessarily suitable for all tasks. However, for tasks for which it is suitable, it provides greater flexibility in how that task might be carried out (and thus a better chance of being able to meet any parameter constraints specified by the user). For example, for a task for training a machine learning model using images, the task may be implemented by a single hardware component (e.g. a single GPU) if the images are black and white or by two hardware components (e.g. two GPUs or one GPU and one FPGA) if the images are in colour. In the latter case, the task is split into subtasks which are carried out in parallel by the two hardware components. This is acceptable as long as the required data flow rate between subtasks can be satisfied by the interconnects between the two hardware components.

Thus, in general, each task represented by a node in the condensed task graph 605 may comprise subtasks requiring a threshold data flow rate between subtasks. The task must therefore be carried out by hardware which can satisfy this threshold data flow rate. In the examples of FIGS. 4 and 5, this requires each task to be processed by a single hardware component. However, in other examples, the processing of one or more of the tasks (e.g. those comprising subtasks which can be carried out in parallel) may be distributed amongst multiple hardware components in a hardware set whilst still satisfying the threshold data flow rate between subtasks.

In an example, a plurality of hardware components or hardware sets may be allocated to the same task. The hardware component or set used to perform that task is then selected as the set of tasks are carried out based on a property of the input data at any given time. For example, if the input data is an image, a different hardware component or set may be chosen for a particular task depending on the data size of the image. An image data size threshold may be set. For images with a data size less than or equal to the threshold, the task is performed by an allocated CPU. For images with a data size greater than the threshold, the task is performed by an allocated GPU. In this case, the same executable file may be used. However, the executable file will define the threshold (e.g. in the form of an IF statement) such that is executed by either the specified CPU or the specified GPU depending on the data size of the current image.

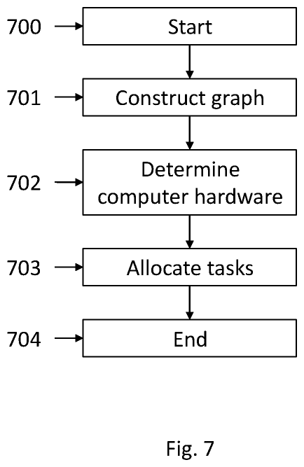

FIG. 7 shows a method according to an embodiment. The method is performed by the processor 201.

The methods starts at step 700.

At step 701, a graph comprising a plurality of nodes and edges is constructed. Each node represents a respective computational task and each edge represents a data flow between computational tasks. This is exemplified in FIG. 3.

At step 702, one or more instances of available computer hardware capable of performing each computational task are determined.

At step 703, each computational task is allocated to one or more of the one or more instances of computer hardware determined for that computational task such that a data bandwidth between the one or more instances of computer hardware to which each computational task is allocated satisfies a data flow requirement between each computational task. This is exemplified in FIGS. 4 and 5, in which the required input and output data flow rates of the hardware component to which a given task is allocated represent the required input and output data bandwidth of that hardware component. In this example, each task is allocated to a single instance of computer hardware. However, as discussed, for some tasks (e.g. those which can be carried out as a plurality of parallel subtasks), these may be allocated to a hardware set (comprising multiple instances of hardware) if the data flow rate requirements between subtasks can be satisfied by this hardware set.

The method ends at step 704.

Some embodiments of the present technique are defined by the following numbered clauses:
1. A computer-implemented method of allocating computational tasks to computer hardware, the method comprising:
   constructing a graph comprising a plurality of nodes and edges, each node representing a respective computational task and each edge representing a data flow between computational tasks;
   determining one or more instances of available computer hardware capable of performing each computational task; and
   allocating each computational task to one or more of the one or more instances of computer hardware determined for that computational task such that a data bandwidth between the one or more instances of computer hardware to which each computational task is allocated satisfies a data flow requirement between each computational task.
2. A computer-implemented method according to clause 1, wherein the one or more instances of available computer hardware capable of performing each computational task comprise one or more of a central processing unit, CPU, a graphics processing unit, GPU, a field-programmable gate array, FPGA and a tensor processing unit, TPU.
3. A computer-implemented method according to any preceding clause, comprising: obtaining source code;
   parsing the source code to determine a preliminary set of computational tasks;
   determining a subset of computational tasks in the preliminary set to be performed by the same one or more instances of hardware; and
   representing the subset of computational tasks as a single node of the graph.
4. A computer-implemented method according to any preceding clause, wherein the instances of computer hardware to which the computational tasks are allocated are chosen to satisfy one or more additional performance parameters.
5. A computer-implemented method according to clause 4, wherein the one or more additional performance parameters include one or more of power efficiency and cost.
6. A computer-implemented method according to any preceding clause, wherein the instances of computer hardware to which the computational tasks are allocated comprise one or more of local and cloud-based hardware instances.
7. A computer-implemented method according to any preceding clause, wherein the computational tasks are for training a machine learning algorithm.
8. An information processing apparatus for allocating computational tasks to computer hardware, the apparatus comprising circuitry configured to:
   construct a graph comprising a plurality of nodes and edges, each node representing a respective computational task and each edge representing a data flow between computational tasks;
   determine one or more instances of available computer hardware capable of performing each computational task; and
   allocate each computational task to one or more of the one or more instances of computer hardware determined for that computational task such that a data bandwidth between the one or more instances of computer hardware to which each computational task is allocated satisfies a data flow requirement between each computational task.
9. An information processing apparatus according to clause 8, wherein the one or more instances of available computer hardware capable of performing each computational task comprise one or more of a central processing unit, CPU, a graphics processing unit, GPU, a field-programmable gate array, FPGA and a tensor processing unit, TPU.
10. An information processing apparatus according to clause 8 or 9, wherein the circuitry is configured to:
   obtain source code;
   parse the source code to determine a preliminary set of computational tasks;
   determine a subset of computational tasks in the preliminary set to be performed by the same one or more instances of hardware; and
   represent the subset of computational tasks as a single node of the graph.
11. An information processing apparatus according to any one of clauses 8 to 10, wherein the instances of computer hardware to which the computational tasks are allocated are chosen to satisfy one or more additional performance parameters.
12. An information processing apparatus according to clause 11, wherein the one or more additional performance parameters include one or more of power efficiency and cost.
13. An information processing apparatus according to any one of clauses 8 to 12, wherein the instances of computer hardware to which the computational tasks are allocated comprise one or more of local and cloud-based hardware instances.
14. An information processing apparatus according to any one of clauses 8 to 13, wherein the computational tasks are for training a machine learning algorithm.
15. A program for controlling a computer to perform a method according to any one of clauses 1 to 7.
16. A computer-readable storage medium storing a program according to clause 15.

Numerous modifications and variations of the present disclosure are possible in light of the above teachings. It is therefore to be understood that, within the scope of the claims, the disclosure may be practiced otherwise than as specifically described herein.

In so far as embodiments of the disclosure have been described as being implemented, at least in part, by one or more software-controlled information processing apparatuses, it will be appreciated that a non-transitory machine-readable medium carrying such software, such as an optical disk, a magnetic disk, semiconductor memory or the like, is also considered to represent an embodiment of the present disclosure.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more computer processors (e.g. data processors and/or digital signal processors). The elements and components of any embodiment may be physically, functionally and logically implemented in any suitable way. Indeed the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to these embodiments. Additionally, although a feature may appear to be described in connection with particular embodiments, one skilled in the art would recognize that various features of the described embodiments may be combined in any manner suitable to implement the present disclosure.

1. A computer-implemented method of allocating computational tasks to computer hardware, the method comprising:
constructing a graph comprising a plurality of nodes and edges, each node representing a respective computational task and each edge representing a data flow between computational tasks;
determining one or more instances of available computer hardware capable of performing each computational task; and
allocating each computational task to one or more of the one or more instances of computer hardware determined for that computational task such that a data bandwidth between the one or more instances of computer hardware to which each computational task is allocated satisfies a data flow requirement between each computational task.

2. A computer-implemented method according to claim 1, wherein the one or more instances of available computer hardware capable of performing each computational task comprise one or more of a central processing unit, CPU, a graphics processing unit, GPU, a field-programmable gate array, FPGA and a tensor processing unit, TPU.

3. A computer-implemented method according to any preceding claim, comprising:
obtaining source code;
parsing the source code to determine a preliminary set of computational tasks;
determining a subset of computational tasks in the preliminary set to be performed by the same one or more instances of hardware; and
representing the subset of computational tasks as a single node of the graph.

4. A computer-implemented method according to any preceding claim, wherein the instances of computer hardware to which the computational tasks are allocated are chosen to satisfy one or more additional performance parameters.

5. A computer-implemented method according to claim 4, wherein the one or more additional performance parameters include one or more of power efficiency and cost.

6. A computer-implemented method according to any preceding claim, wherein the instances of computer hardware to which the computational tasks are allocated comprise one or more of local and cloud-based hardware instances.

7. A computer-implemented method according to any preceding claim, wherein the computational tasks are for training a machine learning algorithm.

8. An information processing apparatus for allocating computational tasks to computer hardware, the apparatus comprising circuitry configured to:
construct a graph comprising a plurality of nodes and edges, each node representing a respective computational task and each edge representing a data flow between computational tasks;
determine one or more instances of available computer hardware capable of performing each computational task; and
allocate each computational task to one or more of the one or more instances of computer hardware determined for that computational task such that a data bandwidth between the one or more instances of computer hardware to which each computational task is allocated satisfies a data flow requirement between each computational task.

9. An information processing apparatus according to claim 8, wherein the one or more instances of available computer hardware capable of performing each computational task comprise one or more of a central processing unit, CPU, a graphics processing unit, GPU, a field-programmable gate array, FPGA and a tensor processing unit, TPU.

10. An information processing apparatus according to claim 8 or 9, wherein the circuitry is configured to:
obtain source code;
parse the source code to determine a preliminary set of computational tasks;
determine a subset of computational tasks in the preliminary set to be performed by the same one or more instances of hardware; and
represent the subset of computational tasks as a single node of the graph.

11. An information processing apparatus according to any one of claims 8 to 10, wherein the instances of computer hardware to which the computational tasks are allocated are chosen to satisfy one or more additional performance parameters.

12. An information processing apparatus according to claim 11, wherein the one or more additional performance parameters include one or more of power efficiency and cost.

13. An information processing apparatus according to any one of claims 8 to 12, wherein the instances of computer hardware to which the computational tasks are allocated comprise one or more of local and cloud-based hardware instances.

14. An information processing apparatus according to any one of claims 8 to 13, wherein the computational tasks are for training a machine learning algorithm.

15. A program for controlling a computer to perform a method according to any one of claims 1 to 7.

16. A computer-readable storage medium storing a program according to claim 15.
